(19) United States
(12) Patent Application Publication
(10) Pub. No.: US 2024/0290562 A1
(43) Pub. Date: Aug. 29, 2024

(54) TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 18/585,860

(22) Filed: Feb. 23, 2024

(30) Foreign Application Priority Data
Feb. 28, 2023 (DE) 10 2023 104 807.4

(51) Int. Cl. H01H 37/54

(52) U.S. Cl. CPC H01H 37/5427; H01H 2037/549

(57) ABSTRACT

A temperature-dependent switch having first and second stationary contacts and a temperature-dependent switching mechanism comprising a current transfer member and a temperature-dependent switching element. The temperature-dependent switching mechanism is configured to switch in a temperature-dependent manner between a closed state, in which the current transfer member is pressed against the first and second stationary contacts so that an electrically conductive connection is established, and an open state, in which the current transfer member is held at a distance from the first and second stationary contacts and, thus, the electrically conductive connection is interrupted. The current transfer member comprises a first section which, in the closed state, is pressed against the first and second stationary contacts, and a second section which projects from the first section and is integrally connected to the first section and which is passed through an opening provided in the temperature-dependent switching element.

### CROSS-REFERENCE TO RELATED APPLICATIONS

This application claims priority from German patent application DE 10 2023 104 807.4, filed on Feb. 28, 2023. The entire content of this priority application is incorporated herein by reference.

### FIELD

The present disclosure generally relates to a temperature-dependent switch.

### BACKGROUND

Generic temperature-dependent switches are disclosed in, for example, DE 10 2013 101 392 A1 and DE 10 2019 112 074 A1.

Such temperature-dependent switches are used in a principally known manner to monitor the temperature of a device. For this purpose, the switch is brought into thermal contact with the device to be protected, e.g. via one of its outer surfaces, so that the temperature of the device to be protected influences the temperature of the switching mechanism arranged inside the switch.

The switch is typically connected electrically in series into the supply circuit of the device to be protected via connecting cables, so that the supply current of the device to be protected flows through the switch below the response temperature of the switching mechanism.

The temperature-dependent switching mechanism arranged inside the switch comprises a temperature-dependent switching element that is responsible for the temperature-dependent switching behavior of the switch. This temperature-dependent switching element ensures that the switching mechanism establishes an electrically conductive connection between the two stationary contacts of the switch at low temperatures and interrupts this electrically conductive connection at higher temperatures.

Among others, the terms “closed state” and “open state” are used herein. With the term “closed state” or the equivalent term “low-temperature state,” the position of the switch is that which it assumes as long as the switch or the switching mechanism has a temperature below the response temperature. In this closed state or low-temperature state, the switch is closed so that current can flow through the switch via the switching mechanism. With the term “open state” or the equivalent term “high-temperature state,” the position of the switch is that which it assumes when the temperature of the switch or the switching mechanism exceeds the response temperature. In this open state or high-temperature state, the switch is open, which means that the current flow is interrupted by the switching mechanism.

The temperature-dependent switching element responsible for the temperature-dependent switching function of the switching mechanism is usually designed as a bimetallic element in such switches. Such a bimetallic element is usually configured as a multi-layered, active, sheet metal-shaped device consisting of two, three or four interconnected components with different thermal expansion coefficients. The individual metal and metal alloy layers of such bimetal elements are usually joined in a material locking or positive locking manner and are achieved, for example, by rolling.

Such bimetallic element comprises a first stable geometric configuration (low-temperature configuration) at low temperatures, below its response temperature, and a second stable geometric configuration (high-temperature configuration) at high temperatures, above its response temperature. Depending on the temperature, the bimetallic element switches from its low-temperature configuration to its high-temperature configuration and vice versa in the manner of a hysteresis.

In the switches disclosed in DE 10 2013 101 392 A1 and DE 10 2019 112 074 A1, a bimetallic disc is provided as a temperature-dependent switching element. In the aforementioned switches, this bimetallic disc is connected via a rivet to a current transfer member which is disc- or plate-shaped. The rivet serves on the one hand as a connecting element between the bimetallic disc and the current transfer member and on the other hand also acts as a support for the bimetallic disc. The rivet is guided through both a hole provided centrally in the bimetallic disc and a hole provided centrally in the current transfer member.

Furthermore, the switching mechanism of the switches disclosed in the two documents mentioned above comprises a spring disc, which is also penetrated centrally by the rivet and is held captively together with the bimetallic disc and the current transfer member by means of the rivet. In the closed state or low-temperature state of the switch, this spring disc provides the contact pressure with which the current transfer member is pressed against the two stationary contacts.

The current transfer member, configured as a type of contact plate, is either made entirely of electrically conductive material or is coated on its top side with an electrically conductive material, so that the current transfer member ensures the electrically conductive connection between these two stationary contacts in the closed state or low-temperature state of the switch by coming into contact with the two stationary contacts.

The advantage of this type of configuration of the switching mechanism, in which the electrically conductive connection between the two stationary contacts of the switch is established via a single current transfer member, is in particular that no current flows through the bimetallic disc or the temperature-dependent switching element and the spring disc (if present) in the closed state or low-temperature state of the switch, as only the current transfer member acts as a current-carrying device of the switching mechanism. This has a positive effect on the switching function and service life of the bimetallic disc. Switches of this type can therefore be used to monitor electrical devices that are operated with comparatively high current levels.

Although switches with such a configuration have proven to be advantageous in practice for the reasons mentioned, there is still room for improvement.

It has been found that the aforementioned connection of the temperature-dependent switching element to the current transfer member, which is made using a rivet, has various disadvantages. Firstly, a central hole must be provided in both the temperature-dependent switching element and the current transfer member. This not only requires an extra production step during the manufacture of the switching element, but also weakens the material of the components, which in particular leads to disadvantages in the current transfer member. The material of the current transfer member is weakened by the central hole through which the rivet is passed, which impairs its stability. In addition, the contact mass of the current transfer member decreases by the central hole in the current transfer member, which leads to a lower power density. As a result, the level of current conductivity of the current transfer member is impaired in particular.

### SUMMARY

It is an object to provide a switch that overcomes the above-mentioned disadvantages. It is, in particular, an object to increase the current conductivity of the switch in order to be able to insert the switch for monitoring electrical devices which are operated with even higher currents.

According to an aspect, a temperature-dependent switch is presented, which comprises a first stationary contact, a second stationary contact, and a temperature-dependent switching mechanism having a current transfer member and a temperature-dependent switching element, wherein the temperature-dependent switching element has an opening and is con-figured to change its shape in a temperature-dependent manner between a geo-metric low-temperature configuration and a geometric high-temperature configuration, wherein the temperature-dependent switching mechanism is configured to switch by means of the temperature-dependent switching element in a temperature-dependent manner between a closed state, in which the current transfer member is pressed against the first stationary contact and the second stationary contact in or-der to establish an electrically conductive connection between the first stationary contact and the second stationary contact via the current transfer member, and an open state, in which the current transfer member is held at a distance from the first stationary contact and the second stationary contact in order to interrupt the electrically conductive connection, wherein the current transfer member comprises a first section which, in the closed state, is pressed against the first stationary contact and the second stationary con-tact and bears with a top side of the first section against the first stationary contact and the second stationary contact, wherein the current transfer member comprises a second section which projects from the first section and is integrally formed in one piece with the first section, and wherein the second section is passed through the opening of the temperature-dependent switching element.

The riveted connection that is sometimes used according to the prior art as mentioned above is thus replaced by another type of configuration of the current transfer member. A part of the current transfer member itself, namely its second section, is passed through the opening provided in the temperature-dependent switching element, which opening, for example, can still be configured as a central hole in the switching element.

This second section of the current transfer member is integrally formed in one piece with the first section of the current transfer member, which is pressed against the two stationary contacts in the closed state or low-temperature state of the switch and is preferably essentially disc-shaped or plate-shaped in the manner of a contact plate. Accordingly, no hole needs to be provided within the current transfer member.

As a result, the total mass and thus the contact mass of the current transfer member can be increased, which means that the current transfer member can be more massive overall and thus more stable. As a result, the current transfer member provides a greater power density, so that the switch is suitable for conducting currents with a comparatively high current intensity in its closed state or low-temperature state.

In a further refinement, the second section may project perpendicularly from the first section.

The second section preferably forms a kind of extension or pin that projects from the bottom side of the first section and is integrally connected to it. On the one hand, this enables a problem-free connection to the temperature-dependent switching element and, on the other hand, ensures a compact size of the switching mechanism.

Preferably, the second section projects from a center of the first section on one side.

In a further refinement, the second section may be at least partially cylindrical.

In other words, at least part of the second section is preferably cylindrical in shape. With a “cylindrical” shape, the present term does not necessarily mean a circular cylindrical shape, but any shape of the second section whose cross-sectional shape is constant along the longitudinal axis of the second section. For example, a cuboid or prismatic body that fulfills the present requirement is also to be understood as “cylindrical” in the present sense.

Preferably, the current transfer member is rotationally symmetrical. Particularly preferably, the current transfer member is rotationally symmetrical with respect to a central longitudinal axis of the second section. This enables an optimum force distribution between the two stationary contacts and the current transfer member in the closed state or low-temperature state of the switch.

In a further refinement, the first section of the current transfer member is essentially disc-shaped or plate-shaped.

The first section of the current transfer member can therefore be shaped similarly to the entire current transfer member of the switches known from DE 10 2013 101 392 A1 and DE 10 2019 112 074 A1. In contrast to these switches, however, no central hole is provided in the current transfer member, but instead a solidly configured second section is arranged centrally on the first section as a kind of one-sided extension.

In a further refinement, the temperature-dependent switching mechanism further comprises a support ring extending around the second section of the current transfer member and being captively retained to the second section.

The support ring is fixed to the current transfer member as a separate component. The support ring can, for example, be held captive on the second section or on the current transfer member by a shaped, widened edge arranged at a free end of the second section of the current transfer member.

This support ring has the advantage that it can be produced easily and separately from the current transfer member and can be connected to it in a simple way. The support ring enables a simple way of connecting the temperature-dependent switching element to the current transfer member.

Preferably, the temperature-dependent switching element is held captive with the current transfer member by the support ring. This enables the switching mechanism to be manufactured as a semi-finished product during the production of the switch. The switching mechanism pre-produced as a semi-finished product can thus be inserted into the housing of the switch as a whole in an automated way, which simplifies assembly many times over compared to a switching mechanism consisting of several loosely assembled parts.

In a further refinement, a central inner edge of the temperature-dependent switching element extending around the opening is arranged between the support ring and the first section of the current transfer member.

Preferably, an inner diameter of the opening provided in the temperature-dependent switching element is smaller than an outer diameter of the support ring.

The temperature-dependent switching element is thus held captive on the support ring and is thus also captively connected to the current transfer member. Preferably, the temperature-dependent switching element is not fixed to the support ring, but is held captive on it, but with play. This guarantees sufficient freedom of movement of the temperature-dependent switching element, which is advantageous for reproducible switching behavior.

In a further refinement, at least in the open state, the temperature-dependent switching element is supported with its inner edge on the support ring.

In the open state of the switch, the temperature-dependent switching element therefore presses on the support ring, which in turn is connected to the current transfer member, so that the current transfer member is lifted off the two stationary contacts and the electrical connection between them is interrupted.

In a further refinement, the temperature-dependent switching mechanism further comprises a temperature-independent spring element which is configured to press the current transfer member against the first and second stationary contacts in the closed state or low-temperature state of the switch.

The additional provision of such a spring element has the advantage, in particular, that it relieves the temperature-dependent switching element. In the closed state or low-temperature state of the switch, the contact pressure with which the current transfer member is pressed against the two stationary contacts can be generated by the spring element. In contrast, the temperature-dependent switching element can be stored almost force-free in the closed state or low-temperature state of the switch. This has a positive effect on the service life of the temperature-dependent switching element and means that the switching point, i.e. the response temperature of the temperature-dependent switching element, does not change even after many switching cycles.

In a further refinement, the second section of the current transfer member is passed through a second opening provided in the temperature-independent spring element.

Thus, the second section of the current transfer member preferably passes through both the opening provided in the temperature-dependent switching element and the second opening provided in the temperature-independent spring element. The temperature-dependent switching element and the temperature-independent spring element are preferably arranged one above the other.

In a further refinement, a central inner edge of the temperature-independent spring element extending around the second opening is arranged between the support ring and the first section of the current transfer member.

An inner diameter of the second opening provided in the temperature-independent spring element is preferably smaller than an outer diameter of the support ring. Thus, the spring element is also preferably held captive on the support ring. The switching mechanism comprising the current transfer member, the support ring, the spring element and the switching element thus preferably forms a unit that is captively held together.

The temperature-dependent switching element preferably comprises a bimetallic disc that has two temperature-dependent, geometrically stable configurations (low-temperature configuration and high-temperature configuration).

The temperature-independent spring element preferably comprises a bistable snap-action disc that has two temperature-independent geometrically stable positions. This is referred to as a bistable spring disc.

If both a bimetallic disc and a snap-action spring disc are provided, it is in particular preferred that the bimetallic disc acts on the snap-action spring disc during the transition from its low-temperature configuration to its high-temperature configuration in such a way that the snap-action spring disc jumps from its first stable position to its second stable position.

In a further refinement, the switch further comprises a housing on which the first and second stationary contacts are arranged and in which the switching mechanism is arranged.

This measure helps ensure that the switching mechanism is protected against the ingress of dirt. The housing can be an individual housing of the switch or a pocket on the device to be protected from overheating.

In a further refinement, the housing comprises a lower part closed by a lid part, wherein the first and second stationary contacts are arranged on the lid part. This measure ensures that when the lid part is mounted on the lower part, the geometrically correct assignment between the current transfer member and the two stationary contacts arranged on the lid part is also established at the same time.

It is to be understood that the features mentioned above and those to be explained below can be used not only in the combination indicated in each case, but also in other combinations or on their own, without departing the scope of the present disclosure.

### BRIEF DESCRIPTION OF THE DRAWINGS

FIG. 1 shows a schematic sectional view of an embodiment of the switch, wherein the switch is in its closed state or low-temperature state; and

FIG. 2 shows a schematic sectional view of the embodiment of the switch shown in FIG. 1, wherein the switch is in its open state or high-temperature position.

### DESCRIPTION OF PREFERRED EMBODIMENTS

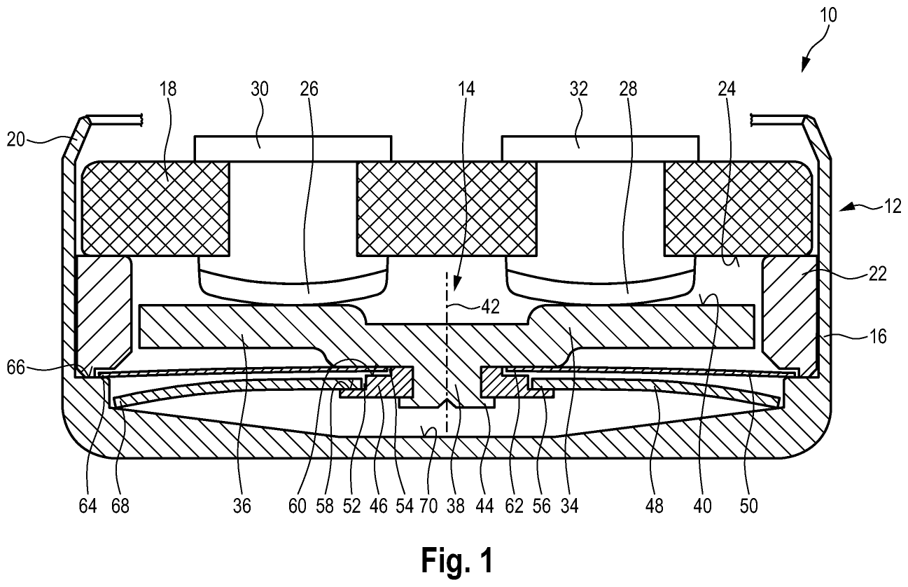

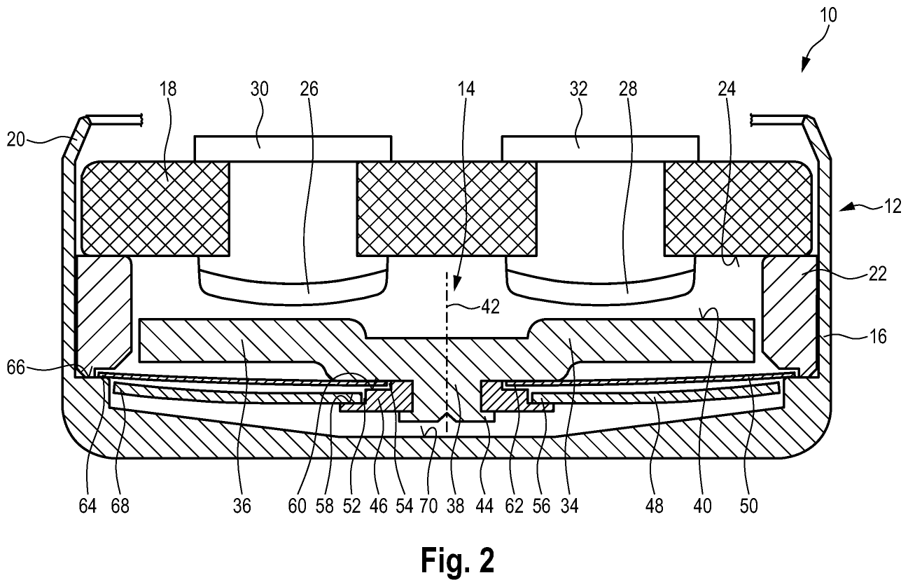

FIGS. 1 and 2 each show a schematic, sectional side view of an embodiment of the switch. In each case, the switch is denoted therein in its entirety with the reference numeral 10.

FIG. 1 shows the closed state or low-temperature position of the switch 10. FIG. 2 shows the open state or high-temperature state of the switch 10.

The switch 10 comprises a housing 12 in which a temperature-dependent switching mechanism 14 is arranged.

The housing 12 comprises a pot-like lower part 16 and a lid part 18 closing the lower part 16. The lid part 18 is held on the lower part 16 by a bent upper edge 20 of the lower part 16. For reasons of clarity, the bent edge 20 is not illustrated extending across the lid part 18 and being bent down completely onto the lid part 18.

The lower part 16 is preferably made of an electrically conductive material, e.g. metal. The lid part 18, on the other hand, is made of electrically insulating material, e.g. plastic or ceramic.

A spacer ring 22 is arranged between the lid part 18 and the lower part 16, which keeps the lid part 18 at a distance from the lower part 16.

The lid part 18 comprises an inner side 24, on which a first stationary contact 26 and a second stationary contact 28 are arranged. The two stationary contacts 26, 28 are each configured as a rivet, which extends through the lid part 18 and ends on the outside in heads 30, 32, which serve for the external connection of the switch 10.

The switching mechanism 14 includes a current transfer member 34 having a disc- or plate-shaped first section 36 and a substantially pin-shaped second section 38 that is integrally connected to this first section. The first section 36 of the current transfer member 34 bears with its top side 40 against the two stationary contacts 26, 28 in the closed state of the switch 10 shown in FIG. 1, so that the current transfer member 34 provides an electrically conductive connection between the two stationary contacts 26, 28 in this switching position. The top side 40 is part of the first section 36.

Accordingly, the current transfer member 34 is made of an electrically conductive material, e.g. metal. The top side 40 of the current transfer member 34 can be coated with an electrically conductive coating to improve conductivity.

The second section 38 of the current transfer member 34 is arranged in the center of the current transfer member 34 and projects downwards on one side from the bottom side of the first section 36 in the manner of an extension. This second section 38 serves, in particular, to fix the other devices of the switching mechanism 14 to the current transfer member 34. The second section 38 projects perpendicularly from the first section 36. The upper part of the second section 38 is cylindrical in shape. At its lower free edge, the second section 38 of the current transfer member 34 comprises a collar 44 with a diameter that is enlarged compared to the cylindrical, upper part of the second section 38.

The current transfer member 34 is preferably solid, i.e. made of solid material, in order to increase its stability and current conductivity. The current transfer member 34 is designed as a body of rotation, which is rotationally symmetrical with respect to a longitudinal axis 42 extending centrally through the second section 38.

A support ring 46 is fixed to the second section 38 of the current transfer member 34. This support ring 46, which can also be referred to as a contact plate, is held captive to the current transfer member 34 by the collar provided at the free lower end of the second section 38 of the current transfer member 34. The support ring 46 extends around the second section 38 of the current transfer member 34. In other words, the second section 38 of the current transfer member 34 extends through the support ring 46.

The switching mechanism 14 also comprises a temperature-dependent switching element 48 and a temperature-independent spring element 50. The temperature-dependent switching element 48 is configured as a bistable bimetallic disc. The spring element 50 is configured as a bistable snap-action spring disc.

The temperature-dependent switching element 48 and the temperature-independent spring element 50 are held together with the current transfer member 34 captively but with play by the support ring 46 fixed to the second section 38. The two disc-shaped elements 48, 50 each comprise an opening 52, 54 in their respective center, with which they are slipped over the second section 38 of the current transfer member 34 from below. These two openings 52, 54 are referred to as “first opening 52” and “second opening 54” in the present case for better differentiation. In other words, the second section 38 of the current transfer member 34 is passed through these two openings 52, 54.

The bimetallic disc forming the temperature-dependent switching element 48 rests with its inner edge 56 on a circular ring-shaped contact surface 58 provided on the support ring 46 on the support ring 46. The spring element 50 configured as a snap-action spring disc is arranged with its inner edge 62 between a shoulder surface 60 provided above the support surface 58 on the support ring 46 and the first section 36 of the current transfer member 34. In the closed state shown in FIG. 1, the spring element 50 is supported with its inner edge 62 on the bottom side of the first section 36 of the current transfer member 34.

The circumferential, outer edge 64 of the spring element 50 is fixed in the housing 12. This outer edge 64 of the spring element 50 rests on a circumferential shoulder 66 provided in the lower part 16 of the housing 12, on which the spacer ring 22 also rests. The outer edge 64 of the spring element 50 is preferably clamped between the spacer ring 22 and the shoulder 66. Since the spring element 50 presses the current transfer member 34 against the current transfer member 34 from below with its inner edge 62, the spring element 50 provides the closing pressure with which the current transfer member 34 is pressed against the two stationary contacts 26, 28 in the closed state or low-temperature state of the switch 10 shown in FIG. 1.

The temperature-dependent switching element 48, configured as a bimetallic disc, rests with its outer edge 68 freely, i.e. without mechanical load, on an inner base 70 of the lower part 16.

According to FIG. 1, the inner base 70 is configured as a conical support shoulder that rises radially outwards and serves as a support surface for the circumferential outer edge 68 of the spring element temperature-dependent switching element 48.

If the temperature of the temperature-dependent switching element 48 now increases, its outer edge 68 in FIG. 1 lifts upwardly, so that the switching element 48, which is designed as a bimetallic disc, jumps from its convex position shown in FIG. 1 to its concave position shown in FIG. 2, in which the outer edge 68 is supported on the inside of the switch 10, in this case on the spring element 50, as can be seen in FIG. 2.

During the transition from its low-temperature configuration shown in FIG. 1 to its high-temperature configuration shown in FIG. 2, the temperature-dependent switching element 48 is thus supported with its circumferential outer edge 68 on the spring element 50, wherein it presses with its inner edge 56 on the support surface 58 provided on the support ring 46 and thereby pushes the current transfer member 34 away from the stationary contacts 26, 28 against the force of the spring element 50.

This preferably jerky snapping movement of the temperature-dependent switching element 48 thus pulls the current transfer member 34 downwards, wherein the spring element 50 simultaneously snaps from its first stable position shown in FIG. 1 into its second stable position shown in FIG. 2.

Thus, while the spring element 50 in its first position shown in FIG. 1 holds the current transfer member 34 in contact with the two stationary contacts 26, 28 when the switch 10 is closed, in its second stable position shown in FIG. 2 it holds the current transfer member 34 at a distance from the two stationary contacts 26, 28 when the switch 10 is open.

While the switch 10 is shown in its closed state in FIG. 1, it is shown in its open state in FIG. 2.

If the temperature of the device to be protected and thus the temperature of the switch 10 now cools down again, the temperature-dependent switching element 48 snaps back from its high-temperature configuration shown in FIG. 2 to its low-temperature configuration shown in FIG. 1, which closes the switch 10 again.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A temperature-dependent switch, comprising:
a first stationary contact;
a second stationary contact; and
a temperature-dependent switching mechanism having a current transfer member and a temperature-dependent switching element;
wherein the temperature-dependent switching element has an opening and is configured to change its shape in a temperature-dependent manner between a geometric low-temperature configuration and a geometric high-temperature configuration,
wherein the temperature-dependent switching mechanism is configured to switch by means of the temperature-dependent switching element in a temperature-dependent manner between a closed state, in which the current transfer member is pressed against the first stationary contact and the second stationary contact in order to establish an electrically conductive connection between the first stationary contact and the second stationary contact via the current transfer member, and an open state, in which the current transfer member is held at a distance from the first stationary contact and the second stationary contact in order to interrupt the electrically conductive connection,
wherein the current transfer member comprises a first section which, in the closed state, is pressed against the first stationary contact and the second stationary contact and bears with a top side of the first section against the first stationary contact and the second stationary contact,
wherein the current transfer member comprises a second section which projects from the first section and is integrally formed in one piece with the first section, and
wherein the second section is passed through the opening of the temperature-dependent switching element.

2. The temperature-dependent switch according to claim 1, wherein the second section projects perpendicularly from the first section.

3. The temperature-dependent switch according to claim 1, wherein at least a part of the second section is cylindrical.

4. The temperature-dependent switch according to claim 1, wherein the first section is disc-shaped or plate-shaped.

5. The temperature-dependent switch according to claim 1, wherein the temperature dependent switching mechanism further comprises a support ring that extends around the second section and is attached to the second section.

6. The temperature-dependent switch according to claim 5, wherein a central inner edge of the temperature-dependent switching element that extends around the opening is arranged between the support ring and the first section.

7. The temperature-dependent switch according to claim 6, wherein, in the open state, the central inner edge of the temperature-dependent switching element is supported on the support ring.

8. The temperature-dependent switch according to claim 1, wherein the temperature-dependent switching mechanism further comprises a temperature-independent spring element configured to press the current transfer member against the first stationary contact and the second stationary contact in the closed state.

9. The temperature-dependent switch as claimed in claim 8, wherein the temperature-independent spring element comprises a second opening, and wherein the second section is passed through the second opening.

10. The temperature-dependent switch as claimed in claim 9, wherein the temperature dependent switching mechanism further comprises a support ring extending around the second section and being attached to the second section, and wherein a central inner edge of the temperature-independent spring element extending around the second opening is arranged between the support ring and the first section.

11. The temperature-dependent switch according to claim 8, wherein the temperature-independent spring element comprises a snap-action disc.

12. The temperature-dependent switch according to claim 1, wherein the temperature-dependent switching element comprises a bimetallic disc.

13. The temperature-dependent switch according to claim 1, wherein the switch further comprises a housing on which the first stationary contact and the second stationary contact are arranged and in which the temperature dependent switching mechanism is arranged.

14. The temperature-dependent switch according to claim 13, wherein the housing comprises a lower part closed by a lid part, and wherein the first stationary contact and the second stationary contact are arranged on the lid part.
